(19) United States
(12) Patent Application Publication
(10) Pub. No.: US 2023/0224952 A1
(43) Pub. Date: Jul. 13, 2023

(54) UPLINK DATA TRANSFER OVER RANDOM ACCESS OR DEDICATED UPLINK RESOURCES

(71) Applicant: QUALCOMM Incorporated, San Diego, CA (US)

(72) Inventors: Ruiming ZHENG, Beijing (CN); Linhai HE, San Diego, CA (US); Miguel GRIOT, La Jolla, CA (US); Ozcan OZTURK, San Diego, CA (US); Gavin Bernard HORN, La Jolla, CA (US)

(21) Appl. No.: 18/000,304

(22) PCT Filed: Jul. 21, 2020
(86) PCT No.: PCT/CN2020/103182

§ 371 Date: Nov. 30, 2022

(51) Int. Cl. H04W 74/00; H04W 72/1268; H04W 76/10; H04W 74/08; H04W 56/00

(52) U.S. Cl. CPC H04W 74/004; H04W 72/1268; H04W 76/10; H04W 74/0833; H04W 56/0045

(57) ABSTRACT

Various aspects of the present disclosure generally relate to wireless communication. In some aspects, a user equipment (UE) may determine, in an inactive state, that uplink data is to be transmitted. The UE may determine whether a timing advance of the UE is valid. The UE may, if the timing advance is not valid, determine whether the uplink data satisfies a transport block size (TB S) threshold. The UE may, based at least in part on whether the uplink data satisfies the TB S threshold, selectively transmit the uplink data via an uplink random access channel (RACH) message or a configured uplink resource, or establish a radio resource control (RRC) connection for the uplink data. Numerous other aspects are provided.

### FIELD OF THE DISCLOSURE

Aspects of the present disclosure generally relate to wireless communication and to techniques and apparatuses for uplink data transfer over random access or dedicated uplink resources.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes: determining, in an inactive state, that uplink data is to be transmitted; determining whether a timing advance of the UE is valid; if the timing advance is not valid, determining whether the uplink data satisfies a transport block size (TBS) threshold; and based at least in part on whether the uplink data satisfies the TBS threshold, selectively: transmitting the uplink data via an uplink random access channel (RACH) message or a configured uplink resource, or establishing a radio resource control (RRC) connection for the uplink data.

In some aspects, a UE includes one or more memories; and one or more processors communicatively coupled to the one or more memories, configured to: determine, in an inactive state, that uplink data is to be transmitted; determine whether a timing advance of the UE is valid; if the timing advance is not valid, determine whether the uplink data satisfies a TBS threshold; and based at least in part on whether the uplink data satisfies the TBS threshold, selectively: transmit the uplink data via an uplink RACH message or a configured uplink resource, or establish a RRC connection for the uplink data.

In some aspects, a non-transitory computer-readable medium storing instructions includes: one or more instructions that, when executed by one or more processors, cause the one or more processors to: determine, in an inactive state, that uplink data is to be transmitted; determine whether a timing advance of the UE is valid; if the timing advance is not valid, determine whether the uplink data satisfies a TBS threshold; and based at least in part on whether the uplink data satisfies the TBS threshold, selectively: transmit the uplink data via an uplink RACH message or a configured uplink resource, or establish a RRC connection for the uplink data.

In some aspects, an apparatus includes: means for determining, in an inactive state, that uplink data is to be transmitted; means for determining whether a timing advance of the apparatus is valid; means for determining, if the timing advance is not valid, whether the uplink data satisfies a TBS threshold; and means for, based at least in part on whether the uplink data satisfies the TBS threshold, selectively: transmitting the uplink data via an uplink RACH message or a configured uplink resource, or establishing a RRC connection for the uplink data.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIG. 3 is a diagram illustrating an example of a four-step random access procedure, in accordance with various aspects of the present disclosure.

FIG. 4 is a diagram illustrating an example of a two-step random access procedure, in accordance with various aspects of the present disclosure.

FIG. 5 is a diagram illustrating an example associated with uplink data transfer over random access or configured uplink resources, in accordance with various aspects of the present disclosure.

FIGS. 6-9 are diagrams illustrating examples associated with uplink data transfer over configured uplink resources in connection with a random access procedure, in accordance with various aspects of the present disclosure.

FIG. 10 is a diagram illustrating an example process associated with uplink data transfer over random access and/or dedicated uplink resources, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

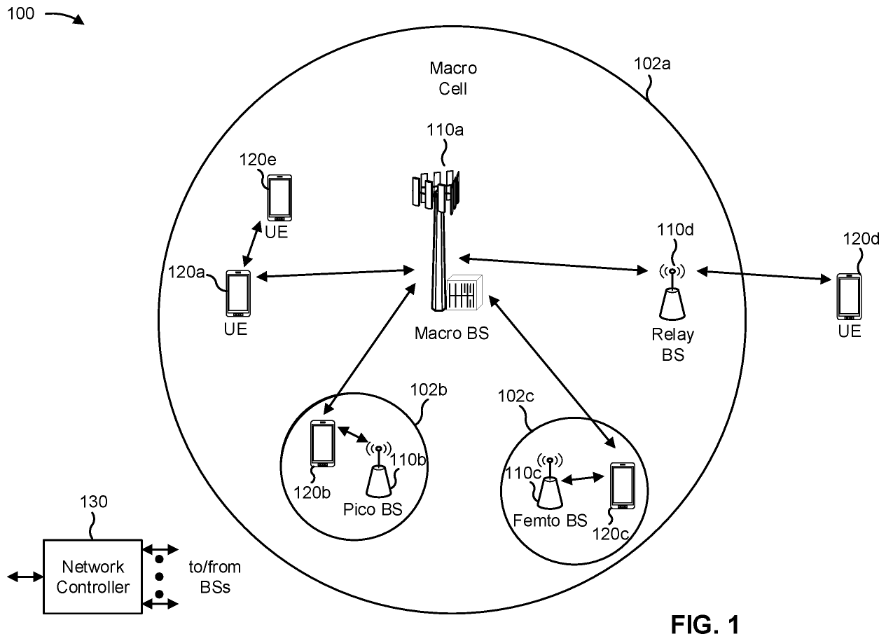

FIG. 1 is a diagram illustrating an example of a wireless network 100, in accordance with various aspects of the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, and/or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

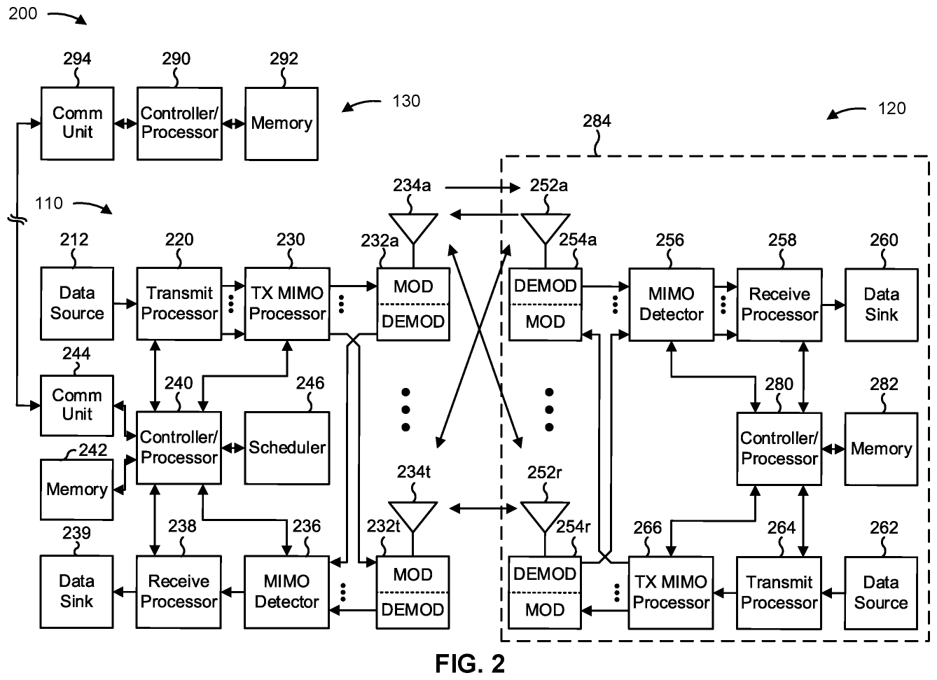

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., a cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

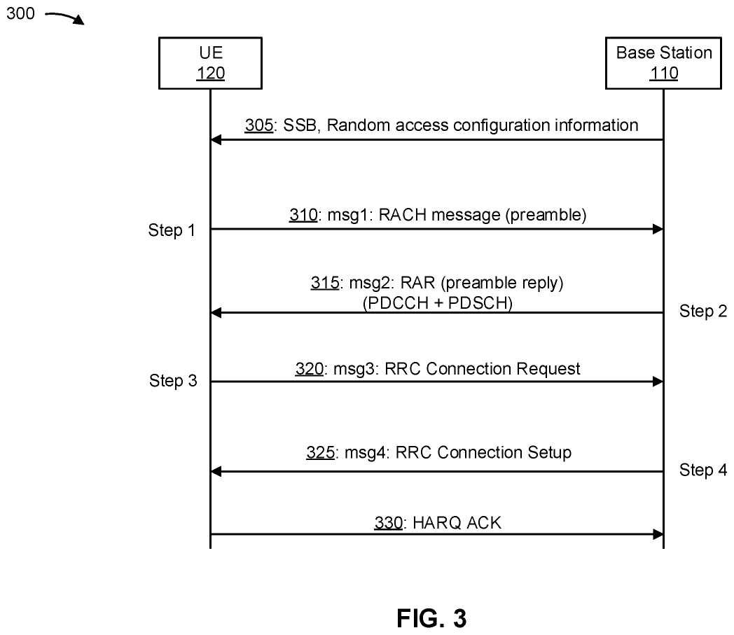

On the uplink, at UE 120, a transmit processor 264 may receive and process data from a data source 262 and control information (e.g., for reports that include RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 3-9.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 3-9.

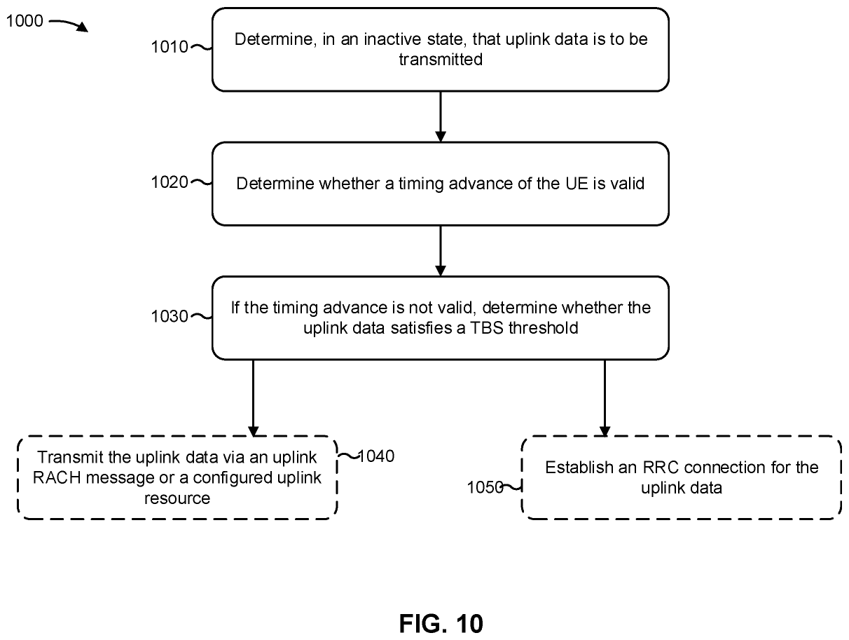

Controller/processor 240 of base station 110, controller/processor 280 of UE 120, and/or any other component(s) of FIG. 2 may perform one or more techniques associated with uplink data transfer over random access or dedicated uplink resources, as described in more detail elsewhere herein. For example, controller/processor 240 of base station 110, controller/processor 280 of UE 120, and/or any other component(s) of FIG. 2 may perform or direct operations of, for example, process 1000 of FIG. 10 and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code, program code, and/or the like) for wireless communication. For example, the one or more instructions, when executed (e.g., directly, or after compiling, converting, interpreting, and/or the like) by one or more processors of the base station 110 and/or the UE 120, may cause the one or more processors, the UE 120, and/or the base station 110 to perform or direct operations of, for example, process 1000 of FIG. 10 and/or other processes as described herein. In some aspects, executing instructions may include running the instructions, converting the instructions, compiling the instructions, interpreting the instructions, and/or the like.

In some aspects, UE 120 may include means for determining, in an inactive state, that uplink data is to be transmitted; means for determining whether a timing advance of the UE is valid; means for determining whether the uplink data satisfies a transport block size (TBS) threshold; means for transmitting the uplink data via an uplink random access channel (RACH) message or a configured uplink resource; means for establishing a radio resource control (RRC) connection for the uplink data; means for transmitting the uplink data via the uplink RACH message if the uplink data fails to satisfy a threshold, wherein failing to satisfy the threshold indicates that the uplink data can be accommodated in the uplink RACH message; means for transmitting the uplink data via the configured uplink resource if the uplink data satisfies the threshold; means for transmitting a request for the configured uplink resource prior to transmitting the uplink data via the configured uplink resource; means for receiving, based at least in part on the request, information configuring the configured uplink resource; means for transmitting the request based at least in part on determining that a periodic transmission is to be performed by the UE; means for receiving an indication of whether to use the threshold or the TBS threshold; means for receiving system information indicating the TBS threshold; means for receiving, via dedicated RRC signaling, information indicating the TBS threshold; means for determining whether the configured uplink resource is configured and the uplink data can be accommodated in the configured uplink resource; means for transmitting the uplink data on the configured uplink resource; means for transmitting a request for another configured uplink resource; means for transmitting the uplink data on the other configured uplink resource; means for initiating a RACH procedure; means for determining whether the uplink data satisfies the TBS threshold; means for transmitting the uplink data in connection with the RACH procedure; means for transmitting a request for the configured uplink resource; means for establishing the RRC connection for the uplink data; means for receiving configuration information indicating the configured uplink resource; and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

A UE may enter an inactive state, such as a radio resource control (RRC) inactive state, to conserve battery power and network resources in times of infrequent data traffic. Entering an active state from the inactive state may involve a random access channel (RACH) procedure or another form of establishment procedure. In many applications, the UE may generate only a small amount of data in a burst of a data session. Examples of such applications include enhanced mobile broadband (eMBB) communications, Internet of Things (IoT) communications, instant messaging applications, social media applications, wearable device applications, and/or the like. It may be wasteful of the UE's resources and network resources to reestablish an RRC connection solely to transmit a small data burst.

Some radio access technologies may provide a service for transmitting a small data transmission in an inactive mode, such as via an uplink RACH message or a configured uplink resource (e.g., a dedicated preconfigured uplink resource, a preconfigured uplink resource, a dedicated uplink resource, and/or the like). However, not all small data transmissions may fit within an uplink RACH message or a configured uplink resource. Furthermore, in some cases, an uplink resource may not be configured for the UE. Therefore, indiscriminately providing a small data transmission via an uplink RACH message or a configured uplink resource (e.g., without regard for the size of the data transmission or the configured uplink resource) may lead to failed uplink transmissions, retransmissions, and/or the like.

Some techniques and apparatuses described herein enable selective transmission of uplink data (e.g., a small data transmission) using an uplink RACH message or a configured uplink resource based at least in part on one or more size thresholds (e.g., a transport block size (TBS) threshold and/or the like). For example, if the uplink data fails to satisfy a size threshold (e.g., is smaller than or equal to, or is smaller than, the size threshold), the UE may transmit the uplink data on an uplink RACH message or a configured uplink resource (e.g., based at least in part on one or more other thresholds or another value associated with the size threshold). If the uplink data satisfies the size threshold (e.g., is larger than, or is larger than or equal to, the size threshold), then the UE may establish an RRC connection to transmit the uplink data. In this way, the UE may selectively provide uplink data via an uplink RACH resource or a configured uplink resource based at least in part on a size of the uplink data. By establishing the RRC connection if the uplink data satisfies the size threshold, the UE may reduce the likelihood of a failed uplink data transmission and reduce latency or delay associated with transmitting larger uplink data transmissions via a configured uplink resource (e.g., via multiple occasions of the configured uplink resource).

FIG. 3 is a diagram illustrating an example 300 of a four-step random access procedure, in accordance with various aspects of the present disclosure. As shown in FIG. 3, a base station 110 and a UE 120 may communicate with one another to perform the four-step random access procedure.

As shown by reference number 305, the base station 110 may transmit, and the UE 120 may receive, one or more synchronization signal blocks (SSBs) and random access configuration information. In some aspects, the random access configuration information may be transmitted in and/or indicated by system information (e.g., in one or more system information blocks (SIBs) and/or the like) and/or an SSB, such as for contention-based random access. Additionally, or alternatively, the random access configuration information may be transmitted in a radio resource control (RRC) message and/or a physical downlink control channel (PDCCH) order message that triggers a RACH procedure, such as for contention-free random access. The random access configuration information may include one or more parameters to be used in the random access procedure, such as one or more parameters for transmitting a random access message, one or more parameters for receiving an RAR, and/or the like.

As shown by reference number 310, the UE 120 may transmit a RACH message, which may include a preamble (sometimes referred to as a random access preamble, a physical random access (PRACH) preamble, a RACH message preamble, and/or the like). The message that includes the preamble may be referred to as a message 1, msg1, MSG1, a first message, an initial message, and/or the like in a four-step random access procedure. The random access message may include a random access preamble identifier.

As shown by reference number 315, the base station 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the base station 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the base station 110 may transmit the PDSCH communication for the RAR, as scheduled by the PDCCH communication. The RAR may be included in a MAC protocol data unit (PDU) of the PDSCH communication.

As shown by reference number 320, the UE 120 may transmit an RRC connection request message. The RRC connection request message may be referred to as message 3, msg3, MSG3, or a third message of a four-step random access procedure. In some aspects, the RRC connection request may include a UE identifier, UCI, a physical uplink shared channel (PUSCH) communication (e.g., an RRC connection request), and/or the like.

As shown by reference number 325, the base station 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, contention resolution information, and/or the like. As shown by reference number 330, if the UE 120 successfully receives the RRC connection setup message, the UE 120 may transmit a hybrid automatic repeat request (HARD) acknowledgment (ACK).

As indicated above, FIG. 3 is provided as an example. Other examples may differ from what is described with regard to FIG. 3.

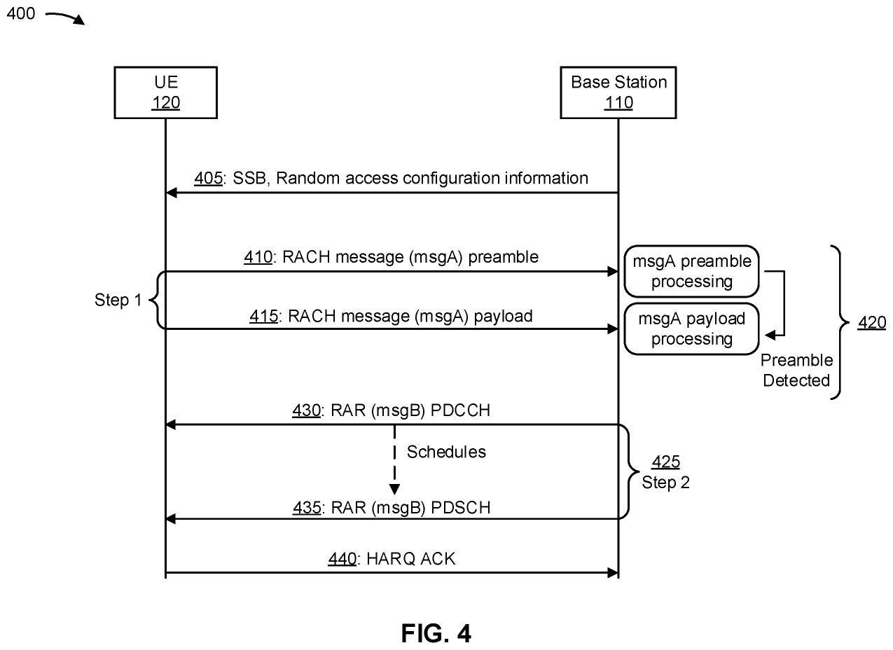

FIG. 4 is a diagram illustrating an example 400 of a two-step random access procedure, in accordance with various aspects of the present disclosure. As shown in FIG. 4, a base station 110 and a UE 120 may communicate with one another to perform the two-step random access procedure.

As shown by reference number 405, the base station 110 may transmit, and the UE 120 may receive, one or more SSBs and random access configuration information. In some aspects, the random access configuration information may be transmitted in and/or indicated by system information (e.g., in one or more SIBs and/or the like) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the two-step random access procedure, such as one or more parameters for transmitting a random access message (referred to herein as a RACH message), receiving a RAR to the RACH message, and/or the like.

As shown by reference number 410, the UE 120 may transmit, and the base station 110 may receive, a RACH message preamble. As shown by reference number 415, the UE 120 may transmit, and the base station 110 may receive, a RACH message payload. As shown, the UE 120 may transmit the RACH message preamble and the RACH message payload to the base station 110 as part of an initial (or first) step of the two-step random access procedure. In some aspects, the RACH message may be referred to as message A, msgA, a first message, an initial message, and/or the like in a two-step random access procedure. Furthermore, in some aspects, the RACH message preamble may be referred to as a message A preamble, a msgA preamble, a preamble, a PRACH preamble, and/or the like, and the RACH message payload may be referred to as a message A payload, a msgA payload, a payload, and/or the like. In some aspects, the RACH message may include some or all of the contents of message 1 (msg1) and message 3 (msg3) of a four-step random access procedure, which is described in more detail below. For example, the RACH message preamble may include some or all contents of message 1 (e.g., a PRACH preamble), and the RACH message payload may include some or all contents of message 3 (e.g., a UE identifier, uplink control information (UCI), a PUSCH transmission, and/or the like).

As shown by reference number 420, the base station 110 may receive the RACH message preamble transmitted by the UE 120. If the base station 110 successfully receives and decodes the RACH message preamble, the base station 110 may then receive and decode the RACH message payload.

As shown by reference number 425, the base station 110 may transmit an RAR (sometimes referred to as an RAR message). As shown, the base station 110 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, contention resolution information, and/or the like.

As shown by reference number 430, as part of the second step of the two-step random access procedure, the base station 110 may transmit a physical downlink control channel (PDCCH) communication for the RAR. The PDCCH communication may schedule a physical downlink shared channel (PDSCH) communication that includes the RAR. For example, the PDCCH communication may indicate a resource allocation (e.g., in downlink control information) for the PDSCH communication.

As shown by reference number 435, as part of the second step of the two-step random access procedure, the base station 110 may transmit the PDSCH communication for the RAR, as scheduled by the PDCCH communication. The RAR may be included in a MAC PDU of the PDSCH communication. As shown by reference number 440, if the UE 120 successfully receives the RAR, the UE 120 may transmit a HARQ ACK.

The establishment of an RRC connection using the RACH procedures shown in FIGS. 3 and 4 may consume significant resources of the UE and the network. Therefore, in some scenarios, it may be inefficient to establish an RRC connection for an uplink data transfer. Techniques and apparatuses described herein enable provision of an uplink data transfer without establishing an RRC connection, for example, if the uplink data transfer is sufficiently small to fit within a RACH message, or a configured uplink resource of the UE. If the uplink data transfer is too large to be provided via a RACH message or a configured uplink resource, then the UE may establish an RRC connection. Thus, communication resources associated with needlessly establishing an RRC connection are conserved. Furthermore, the UE may selectively transmit uplink data on a RACH message and/or a configured uplink resource based at least in part on a size of the uplink data, which improves utilization of communication resources of the UE.

As indicated above, FIG. 4 is provided as an example. Other examples may differ from what is described with regard to FIG. 4.

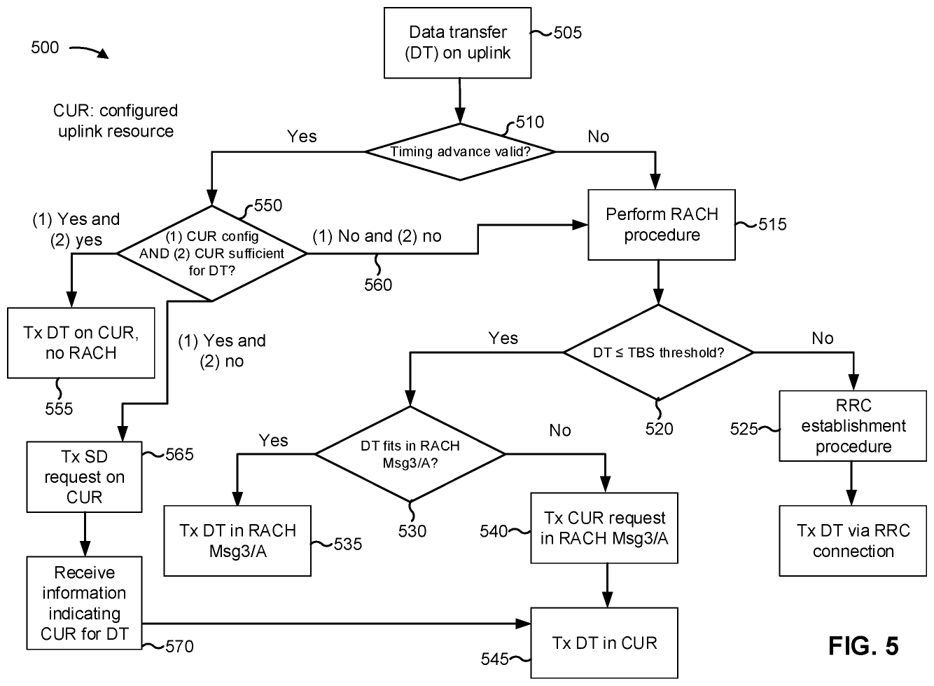

FIG. 5 is a diagram illustrating an example 500 associated with uplink data transfer over random access or configured uplink resources, in accordance with various aspects of the present disclosure. The operations shown in FIG. 5 may be performed by a UE (e.g., UE 120). In example 500, the UE 120 starts in an inactive state, such as an RRC inactive state.

As shown by reference number 505, the UE 120 may determine that data is to be transmitted on the uplink (referred to as a data transfer (DT)). The DT can be associated with any application or source. In some aspects, the DT may be associated with an IoT application, a wearable device application, and/or the like. In some aspects, the DT may be referred to as a small data transmission.

As shown by reference number 510, the UE 120 may determine whether a timing advance (TA) of the UE 120 is valid. A TA value may identify a timing adjustment for an uplink transmission of the UE 120. The UE 120 may determine a TA value based at least in part on a RACH procedure or MAC messaging subsequent to the RACH procedure. For example, the UE 120 may receive the TA value in a RAR or in a TA MAC CE subsequent to the RACH procedure. The UE 120 may determine whether the TA is valid based at least in part on a timer, location information associated with the UE 120, and/or the like.

As shown by reference number 515, if the UE 120 determines that the TA value is not valid (block 510—NO), then the UE 120 may perform a RACH procedure. The UE 120 may perform the RACH procedure to update a TA value associated with the UE 120 so that the UE 120 can successfully transmit the DT.

As shown by reference number 520, the UE 120 may determine whether the DT satisfies a TBS threshold (also referred to herein as a size threshold). The TBS threshold may indicate whether the DT is sufficiently small to be transmitted on a RACH message, such as msg3 or msgA. The CUR is described in more detail below. As shown by reference number 525, if the DT is larger than the TBS threshold (block 520—NO), then the UE 120 may establish an RRC connection and transmit the DT via the RRC connection. For example, the UE 120 may exit an RRC inactive state and may enter an RRC connected state for the transmission of the DT if the DT is larger than the TBS threshold. Example values of the TBS threshold include 328 bits, 504 bits, 680 bits, 936 bits, 1000 bits, 2000 bits, and/or the like.

A BS 110 may configure the TBS threshold for the UE 120. In some aspects, the TBS threshold may include a single threshold. In this case, if the DT satisfies the single threshold (e.g., is larger than the single threshold), then the UE 120 may not be permitted to transmit the DT in the RACH message or the CUR. If the DT fails to satisfy the single threshold (e.g., is smaller than or equal to the single threshold), then the UE 120 may be permitted to transmit the DT in the RACH message or the CUR. In some aspects, the TBS threshold may include multiple thresholds. For example, the BS 110 may configure the UE 120 with the multiple thresholds. In this case, the BS 110 may transmit an RRC parameter to enable or disable whether an alternative TBS can be selected for the UE 120 when a size of the DT is smaller than the TBS threshold (e.g., to enable or disable whether the UE 120 can transmit the DT on the RACH message). The TBS threshold may comprise a set of TBS values that indicate a set of thresholds for transmitting the DT on the RACH message. The BS 110 may activate one or more thresholds, of the set of thresholds, for the UE 120. Thus, the UE 120 can be configured to use different thresholds in different scenarios. References herein to “a TBS threshold” should be understood to encompass “a set of TBS thresholds” or “multiple TBS thresholds.”

In some aspects, the TBS threshold may be signaled in a SIB. For example, the TBS threshold may be broadcasted to all UEs covered by a BS 110. Thus, all of the UEs covered by the BS 110 may be configured with a same TBS threshold. In this case, the BS 110 may provide the TBS threshold in a RACH-ConfigCommon parameter, a RACH-ConfigCommonTwoStepRA-r16 parameter, and/or the like. In some aspects, the BS 110 may signal the TBS threshold in dedicated RRC signaling. For example, the BS 110 may transmit an RRC release message (e.g., with a suspendConfig parameter to move the UE 120 to an RRC inactive state) including the TBS threshold configuration. In some aspects, the TB S threshold can be provided in a RACH-ConfigDedicated parameter.

As shown by reference number 530, if the DT is smaller than or equal to the TBS threshold (block 520—Yes), then the UE 120 may determine whether the DT can be transmitted in a RACH message. For example, the UE 120 may determine whether the DT satisfies an uplink grant threshold indicating whether the UE 120 is permitted to transmit the DT in a RACH message. This uplink grant threshold may include a TBS threshold (e.g., may be configured as part of the TBS threshold) for an uplink grant for a payload of the RACH message. As shown by reference number 535, if the DT can be transmitted in a RACH message (block 530—Yes), then the UE 120 may transmit the DT in a RACH message, such as msgA or msg3. For example, the UE 120 may transmit the DT without entering an RRC connected mode or an RRC active mode, thereby conserving UE and network resources associated with entering the RRC connected mode or the RRC active mode.

As shown by reference number 540, if the DT cannot be transmitted in a RACH message (block 530—No), indicating that the UE 120 is not permitted to transmit the DT in a RACH message, then the UE 120 may transmit a CUR request. In this example, the CUR request is transmitted in a RACH message, though in other examples described herein, the CUR request may be transmitted in another type of message. A CUR may refer to a configured uplink resource, a preconfigured uplink resource, a dedicated uplink resource, a dedicated preconfigured uplink resource (D-PUR), and/or the like. A CUR may be a resource on which the UE 120 can perform an uplink transmission without entering an RRC connected mode or an RRC active mode. In some aspects, a CUR may have a TBS sufficient to transmit the DT in a single transport block, which is referred to as a one-shot CUR. In some aspects, a CUR may comprise multiple resources that are distributed in the time domain, so that the UE 120 can transmit data after transmitting the DT, or can transmit the DT on the multiple resources.

In some aspects, the UE 120 may transmit the CUR request based at least in part on the DT being smaller than or equal to the TBS threshold (indicating that the UE 120 can transmit the DT without establishing an RRC connection) and being too large to transmit on an RRC message. In some aspects, the UE 120 may transmit the CUR request based at least in part on determining that the UE 120 is to perform a subsequent transmission. For example, the UE 120 may transmit the CUR request based at least in part on determining that the UE 120 is associated with potential periodic data for a subsequent transmission.

In some aspects, the UE 120 may transmit the CUR request in a MAC CE. For example, the MAC CE may comprise a BSR MAC CE, such as a short BSR with a byte indicating that the short BSR is a CUR request. As another example, the MAC CE may be specific to the CUR request. For example, the MAC CE may comprise a BSR (e.g., information indicating a logical channel identifier and a data amount associated with the logical channel identifier), information indicating a traffic pattern associated with the DT (e.g., a single transmission traffic pattern, a periodic transmission traffic pattern), a predicted amount of traffic associated with the DT, and/or the like. In some aspects, the UE 120 may transmit the CUR request in an RRC message, such as an RRC resume request message. In this case, an RRC parameter of the RRC message (e.g., an RRCResumeRe quest parameter and/or the like) may indicate an amount of data of the DT and/or a traffic pattern associated with the DT. In some aspects, the UE 120 may transmit the CUR request in a RACH message, such as msgA or msg3. In this case, the CUR request may comprise a resume identifier, an authentication token (e.g., a shortResumeMac-I or a resume MAC-I), and/or the like.

As shown by reference number 545, the UE 120 may transmit the DT in a CUR. For example, the BS 110 may configure the UE 120 with the CUR based at least in part on the CUR request. In some aspects, the BS 110 may provide configuration information configuring the CUR via a RACH message, such as msgB or msg4. In some aspects, the BS 110 may provide the configuration information via an RRC message, such as an RRC release message or an RRC message associated with responding to the CUR request. The CUR can be a one-shot CUR or a multi-shot (e.g., configured grant, periodic, semi-persistent, and/or the like) CUR. In some aspects, the multi-shot CUR may recur until the multi-shot CUR is deactivated or reconfigured. In other words, the multi-shot CUR may have an infinite configuration in the time domain. In some aspects, the CUR may be based at least in part on the CUR request. In some aspects, the CUR may be based at least in part on subscription information associated with the UE 120 (e.g., indicating a set of services applicable to the UE 120), network traffic information (e.g., network traffic statistics) associated with the UE 120 (e.g., associated with a UE context of the UE 120 or a traffic history of the UE 120), and/or the like.

As shown by reference number 550, if the TA value of the UE 120 is valid (block 510—Yes), then the UE 120 may determine whether a CUR is configured for the UE (shown as (1)) and whether the CUR is associated with a size (e.g., a TBS) sufficient to transmit the DT (shown as (2)). For example, in some aspects, the CUR may be configured independently of the RACH procedure. For example, the configuration of the CUR may not involve the RACH procedure. In this case, the BS 110 may configure the CUR via RRC dedicated signaling, such as when the UE 120 is in an RRC connected state or when the UE 120 is in an RRC inactive state.

As shown by reference number 555, if the UE 120 determines that the CUR is configured and is associated with a size sufficient to transmit the DT (block 550—(1) Yes and (2) yes), then the UE 120 may transmit the DT on the CUR without performing a RACH procedure. For example, since the UE 120 has a valid TA, the UE 120 can transmit the DT without updating the TA via the RACH procedure. Thus, the UE 120 may conserve communication resources that would otherwise have been used to perform the RACH procedure.

As shown by reference number 560, if the UE 120 determines that the CUR is not configured (block 550—(1) No and (2) no), then the UE 120 may return to block 515. The UE 120 may then perform the operations described with regard to blocks 520, 525, 530, 535, 540, and 545. Thus, if no CUR is configured, the UE 120 may selectively transmit the DT in a RACH message, a CUR (based at least in part on requesting the CUR), or via an RRC connection, depending on the size of the DT.

As shown by reference number 565, if the UE 120 determines that the CUR is configured and is not of sufficient size to carry the DT (block 550—(1) Yes and (2) no), then the UE 120 may use the CUR to transmit a CUR request. For example, the CUR request may request a CUR of sufficient size to carry the DT (e.g., as a one-shot CUR or a multi-shot CUR). As shown by reference number 570, the UE 120 may receive configuration information configuring the CUR. The configuration information may include at least part of the configuration information described with regard to reference number 545, and the CUR request is described in more detail in connection with reference number 540. As shown, the UE 120 may go to block 545 after receiving the configuration information. For example, the UE 120 may transmit the DT on the CUR configured by the configuration information shown by reference number 570.

As indicated above, FIG. 5 is provided as an example. Other examples may differ from what is described with regard to FIG. 5.

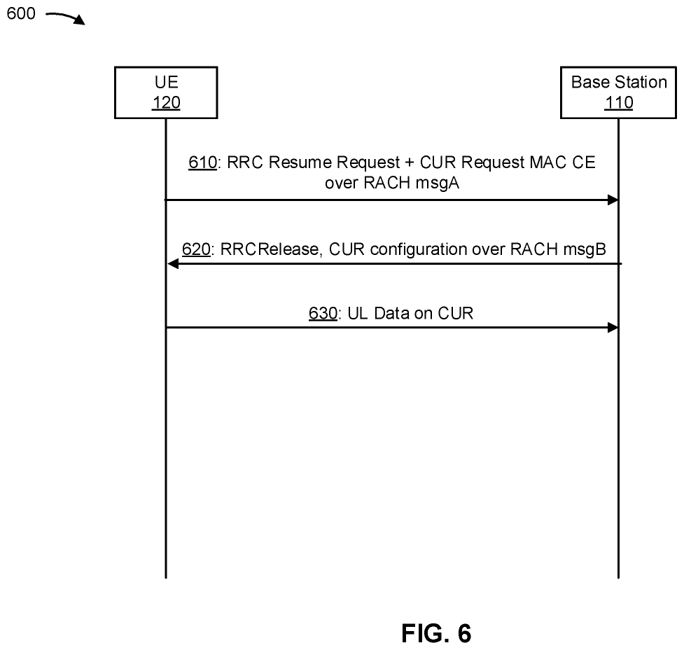

FIGS. 6-9 are diagrams illustrating examples 600, 700, 800, and 900 associated with uplink data transfer over configured uplink resources in connection with a random access procedure, in accordance with various aspects of the present disclosure. Examples 600 and 700 illustrate two-step and four-step RACH procedures where a UE 120 transmits uplink data on a one-shot CUR, whereas examples 800 and 900 illustrate two-step and four-step RACH procedures where a UE 120 transmits uplink data on a multi-shot CUR. For the purpose of examples 600, 700, 800, and 900, the UE 120 has determined that uplink data is to be transmitted.

As shown in FIG. 6, and by reference number 610, the UE 120 may transmit an RRC resume request in a RACH msgA. As further shown, the RRC resume request may include a CUR request, such as a MAC CE indicating the CUR request. As shown by reference number 620, the UE 120 may receive a CUR configuration (e.g., configuration information configuring a CUR) via a RACH message, such as an RRC release message carried by a RACH msgB. As shown by reference number 630, the UE 120 may transmit the uplink data on the CUR configured by the CUR configuration. The example 600 of FIG. 6 may illustrate the operations shown by block 540 and 545 of FIG. 5, and illustrates a procedure for requesting a CUR and performing a one-shot transmission of uplink data in connection with a two-step RACH procedure.

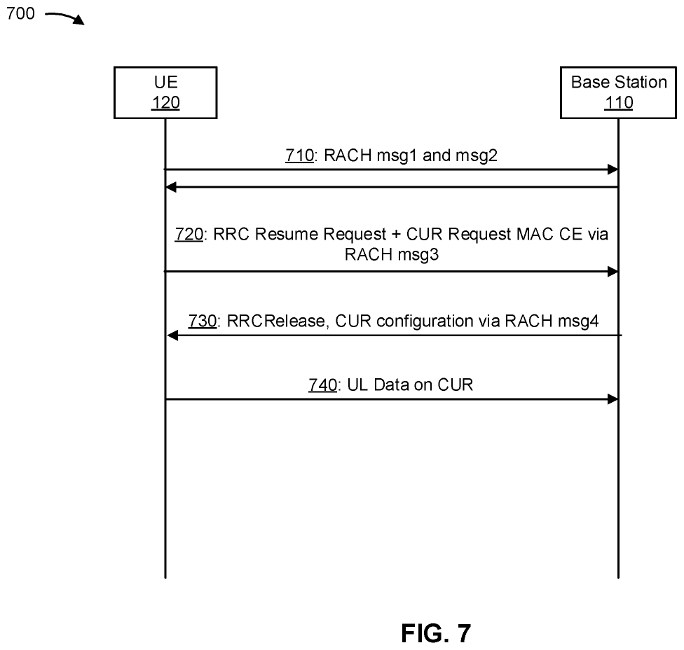

As shown in FIG. 7, and by reference number 710, the UE 120 may transmit RACH msg1 to the BS 110. As shown by reference number 720, the BS 110 may transmit RACH msg2 to the UE 120. As shown by reference number 730, the UE 120 may transmit an RRC resume request in a RACH msg3. As further shown, the RRC resume request may include a CUR request, such as a MAC CE indicating the CUR request. As shown by reference number 740, the UE 120 may receive a CUR configuration (e.g., configuration information configuring a CUR) via a RACH message, such as an RRC release message carried by a RACH msg4. As shown by reference number 750, the UE 120 may transmit the uplink data on the CUR configured by the CUR configuration. The example 700 of FIG. 7 may also correspond to block 540 and 545 of FIG. 5, and illustrates a procedure for requesting a CUR and performing a one-shot transmission of uplink data in connection with a four-step RACH procedure. The UE 120 may remain in an RRC inactive state for the entirety of examples 600 and 700.

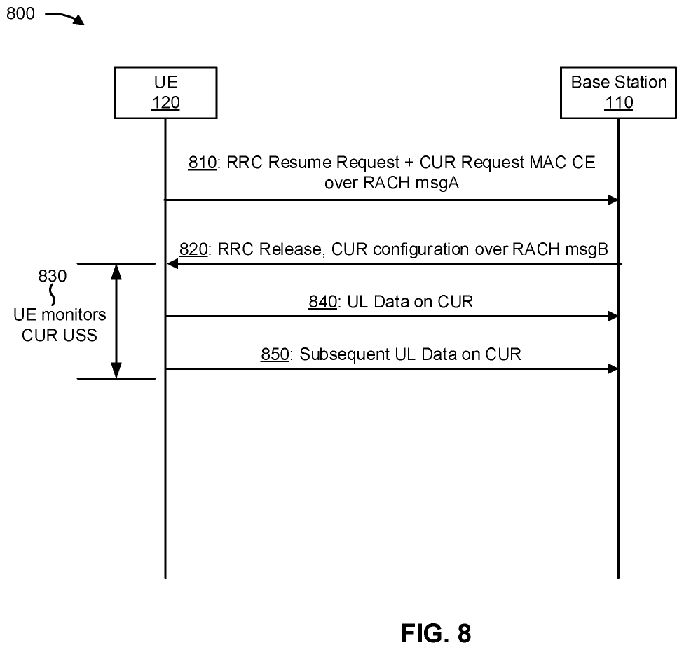

As shown in FIG. 8, and by reference number 810, the UE 120 may transmit an RRC resume request in a RACH msgA. As further shown, the RRC resume request may include a CUR request, such as a MAC CE indicating the CUR request. In this case, the CUR request may request a multi-shot CUR, as described in more detail elsewhere herein. As shown by reference number 820, the UE 120 may receive a CUR configuration (e.g., configuration information configuring a CUR) via a RACH message, such as an RRC release message carried by a RACH msgB. As shown by reference number 830, the UE 120 may monitor a UE-specific search space (USS) associated with the CUR. For example, a USS may carry control information associated with a specific UE (here, the UE 120). Thus, the UE 120 may monitor the USS for scheduling information associated with transmitting the uplink data and subsequent uplink data. For example, as shown by reference number 840, the UE 120 may transmit the uplink data on the CUR configured by the CUR configuration (e.g., based at least in part on receiving scheduling information in the USS indicating to transmit the uplink data on the CUR). Furthermore, as shown by reference number 850, the UE 120 may transmit subsequent uplink data on the CUR (e.g., based at least in part on receiving scheduling information in the USS indicating to transmit the subsequent uplink data on the CUR). The example 800 of FIG. 8 may illustrate the operations shown by block 540 and 545 of FIG. 5, and illustrates a procedure for requesting a CUR and performing a multi-shot transmission of uplink data in connection with a two-step RACH procedure.

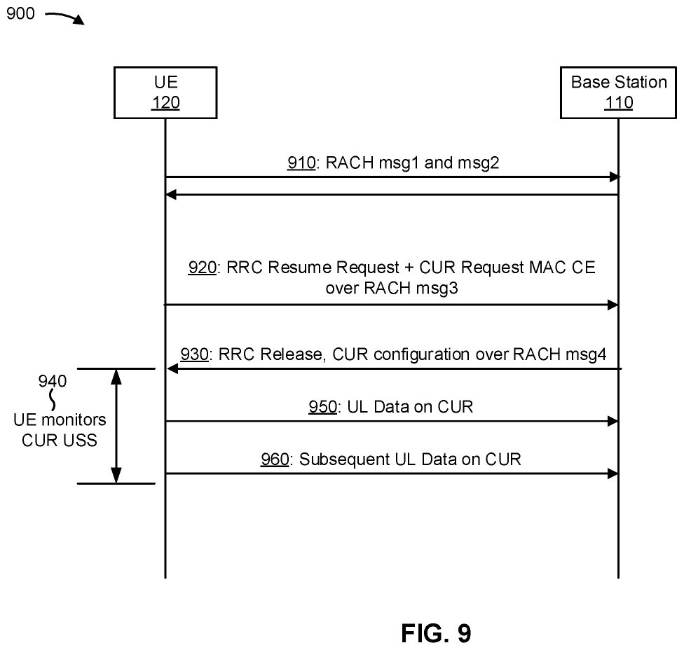

As shown in FIG. 9, and by reference number 910, the UE 120 may transmit RACH msg1 to the BS 110. As shown by reference number 920, the BS 110 may transmit RACH msg2 to the UE 120. As shown by reference number 930, the UE 120 may transmit an RRC resume request in a RACH msg3. As further shown, the RRC resume request may include a CUR request, such as a MAC CE indicating the CUR request. In this case, the CUR request may request a multi-shot CUR, as described in more detail elsewhere herein. As shown by reference number 940, the UE 120 may receive a CUR configuration (e.g., configuration information configuring a CUR) via a RACH message, such as an RRC release message carried by a RACH msg4. As shown by reference number 950, the UE 120 may monitor a USS associated with the CUR. As shown by reference number 960, the UE 120 may transmit the uplink data on the CUR configured by the CUR configuration (e.g., based at least in part on receiving scheduling information in the USS indicating to transmit the uplink data on the CUR). Furthermore, as shown by reference number 970, the UE 120 may transmit subsequent uplink data on the CUR (e.g., based at least in part on receiving scheduling information in the USS indicating to transmit the subsequent uplink data on the CUR). The example 900 of FIG. 9 may illustrate the operations shown by block 540 and 545 of FIG. 5, and illustrates a procedure for requesting a CUR and performing a multi-shot transmission of uplink data in connection with a four-step RACH procedure.

As indicated above, FIGS. 6-9 are provided as examples. Other examples may differ from what is described with regard to FIGS. 6-9.

FIG. 10 is a diagram illustrating an example process 1000 performed, for example, by a user equipment (UE), in accordance with various aspects of the present disclosure. Example process 1000 is an example where the UE (e.g., UE 120 and/or the like) performs operations associated with uplink data transfer over random access or dedicated uplink resources.

As shown in FIG. 10, in some aspects, process 1000 may include determining, in an inactive state, that uplink data is to be transmitted (block 1010). For example, the UE (e.g., using controller/processor 280, transmit processor 264, TX MIMO processor 266, MOD 254, antenna 252, and/or the like) may determine, in an inactive state (e.g., an RRC inactive state), that uplink data is to be transmitted, as described above.

As further shown in FIG. 10, in some aspects, process 1000 may include determining whether a timing advance of the UE is valid (block 1020). For example, the UE (e.g., using antenna 252, DEMOD 254, MIMO detector 256, receive processor 258, controller/processor 280, and/or the like) may determine whether a timing advance of the UE is valid, as described above.

As further shown in FIG. 10, in some aspects, process 1000 may include, if the timing advance is not valid, determining whether the uplink data satisfies a TB S threshold (block 1030). For example, if the timing advance is not valid, the UE (e.g., using receive processor 258, transmit processor 264, controller/processor 280, memory 282, and/or the like) may determine whether the uplink data satisfies a TBS threshold, as described above.

As further shown in FIG. 10, in some aspects, process 1000 may include selectively transmitting the uplink data via an uplink RACH message or a configured uplink resource (block 1040). Additionally, or alternatively, process 1000 may include establishing an RRC connection for the uplink data (block 1050). For example, the UE (e.g., using receive processor 258, transmit processor 264, controller/processor 280, memory 282, and/or the like) may selectively transmit the uplink data via an uplink RACH message or a configured uplink resource, or establish an RRC connection for the uplink data, as described above. In some aspects, the UE may selectively transmit the uplink data via an uplink RACH message or a configured uplink resource, or establish an RRC connection for the uplink data based at least in part on whether the uplink data satisfies the TBS threshold. In some aspects, the UE (e.g., using receive processor 258, transmit processor 264, controller/processor 280, memory 282, and/or the like) may selectively transmit the uplink data via an uplink RACH message and/or a configured uplink resource, or establish an RRC connection for the uplink data, as described above.

Process 1000 may include additional aspects, such as any single aspect or any combination of aspects described below and/or in connection with one or more other processes described elsewhere herein.

In a first aspect, transmitting the uplink data via the uplink RACH message or the configured uplink resource is based at least in part on the uplink data being smaller than or equal to the TBS threshold.

In a second aspect, alone or in combination with the first aspect, establishing the RRC connection is based at least in part on the uplink data being larger than the TBS threshold.

In a third aspect, alone or in combination with one or more of the first and second aspects, transmitting the uplink data via the uplink RACH message or the configured uplink resource further comprises transmitting the uplink data via the uplink RACH message if the uplink data fails to satisfy an uplink grant threshold, wherein failing to satisfy the uplink grant threshold indicates that the uplink data can be accommodated in the uplink RACH message, and transmitting the uplink data via the configured uplink resource if the uplink data satisfies the uplink grant threshold.

In a fourth aspect, alone or in combination with one or more of the first through third aspects, process 1000 includes transmitting a request for the configured uplink resource prior to transmitting the uplink data via the configured uplink resource, and receiving, based at least in part on the request, information configuring the configured uplink resource.

In a fifth aspect, alone or in combination with one or more of the first through fourth aspects, the request is transmitted on the RACH message.

In a sixth aspect, alone or in combination with one or more of the first through fifth aspects, the request indicates that the configured uplink resource is to include a single transport block of sufficient size to carry the uplink data.

In a seventh aspect, alone or in combination with one or more of the first through sixth aspects, the request indicates that the configured uplink resource is to include multiple transport blocks that are distributed in time.

In an eighth aspect, alone or in combination with one or more of the first through seventh aspects, the request indicates that the configured uplink resource includes recurring transport blocks until the configured uplink resource is deactivated

In a ninth aspect, alone or in combination with one or more of the first through eighth aspects, process 1000 includes transmitting the request based at least in part on determining that a periodic transmission is to be performed by the UE.

In a tenth aspect, alone or in combination with one or more of the first through ninth aspects, the request comprises at least one of a medium access control control element, an RRC parameter of an RRC resume request message, or an RRC message.

In an eleventh aspect, alone or in combination with one or more of the first through tenth aspects, the request comprises a buffer status report message including an indication requesting the configured uplink resource.

In a twelfth aspect, alone or in combination with one or more of the first through eleventh aspects, the request includes a buffer status report and a traffic pattern indication associated with the uplink data.

In a thirteenth aspect, alone or in combination with one or more of the first through twelfth aspects, the request further includes a resume identifier associated with the UE and an authentication token associated with the UE.

In a fourteenth aspect, alone or in combination with one or more of the first through thirteenth aspects, the request comprises an RRC parameter indicating an amount of data associated with the uplink data and a traffic pattern indication associated with the uplink data.

In a fifteenth aspect, alone or in combination with one or more of the first through fourteenth aspects, the information configuring the configured uplink resource is received via a downlink RACH message.

In a sixteenth aspect, alone or in combination with one or more of the first through fifteenth aspects, the information configuring the configured uplink resource is received via an RRC release message or an RRC response associated with the request.

In a seventeenth aspect, alone or in combination with one or more of the first through sixteenth aspects, the uplink grant threshold and the TBS threshold are configured by a same configuration message.

In an eighteenth aspect, alone or in combination with one or more of the first through seventeenth aspects, process 1000 includes receiving an indication of whether to use an alternative TBS size for the TBS threshold.

In a nineteenth aspect, alone or in combination with one or more of the first through eighteenth aspects, the TBS threshold is configured with a plurality of values, and wherein the indication indicates a subset of values, of the plurality of values, to be used as the TBS threshold

In a twentieth aspect, alone or in combination with one or more of the first through nineteenth aspects, the TBS threshold is associated with a first value associated with a two-step RACH procedure and a second value associated with a four-step RACH procedure, and wherein selectively transmitting the uplink data via the uplink RACH message is based at least in part on the first value if the uplink RACH message is associated with a two-step RACH procedure and the second value if the uplink RACH message is associated with a four-step RACH procedure.

In a twenty-first aspect, alone or in combination with one or more of the first through twentieth aspects, process 1000 includes receiving system information indicating the TBS threshold.

In a twenty-second aspect, alone or in combination with one or more of the first through twenty-first aspects, process 1000 includes receiving, via dedicated RRC signaling, information indicating the TBS threshold.

In a twenty-third aspect, alone or in combination with one or more of the first through twenty-second aspects, the TBS threshold is associated with a data radio bearer.

In a twenty-fourth aspect, alone or in combination with one or more of the first through twenty-third aspects, the TBS threshold is specific to the UE.

In a twenty-fifth aspect, alone or in combination with one or more of the first through twenty-fourth aspects, transmitting the uplink data via the RACH message or the configured uplink resource further comprises performing a one-shot transmission on the configured uplink resource.

In a twenty-sixth aspect, alone or in combination with one or more of the first through twenty-fifth aspects, transmitting the uplink data via the RACH message or the configured uplink resource further comprises performing multiple transmissions on respective occasions of the configured uplink resource.

In a twenty-seventh aspect, alone or in combination with one or more of the first through twenty-sixth aspects, if the timing advance is determined to be valid, process 1000 includes determining whether the configured uplink resource is configured and the uplink data can be accommodated in the configured uplink resource, and, if the configured uplink resource is configured and the uplink data can be accommodated in the configured uplink resource, transmitting the uplink data on the configured uplink resource.

In a twenty-eighth aspect, alone or in combination with one or more of the first through twenty-seventh aspects, process 1000 includes transmitting a request for another configured uplink resource, and transmitting the uplink data on the other configured uplink resource.

In a twenty-ninth aspect, alone or in combination with one or more of the first through twenty-eighth aspects, the other configured uplink resource has a larger transport block size than the configured uplink resource.

In a thirtieth aspect, alone or in combination with one or more of the first through twenty-ninth aspects, the request for the other configured uplink resource is transmitted in the configured uplink resource.

In a thirty-first aspect, alone or in combination with one or more of the first through thirtieth aspects, process 1000 includes initiating a RACH procedure, determining whether the uplink data satisfies the TBS threshold, and based at least in part on whether the uplink data satisfies the TBS threshold, selectively transmitting the uplink data in connection with the RACH procedure, transmitting a request for the configured uplink resource, or establishing the RRC connection for the uplink data.

In a thirty-first aspect, alone or in combination with one or more of the first through thirtieth aspects, process 1000 includes receiving configuration information indicating the configured uplink resource.

In a thirty-second aspect, alone or in combination with one or more of the first through thirty-first aspects, the configuration information is based at least in part on subscription information associated with the UE.

In a thirty-third aspect, alone or in combination with one or more of the first through thirty-second aspects, the configuration information is based at least in part on network traffic information associated with the UE.

In a thirty-fourth aspect, alone or in combination with one or more of the first through twenty-third aspects, the configured uplink resource is configured independently of whether the UE determines that uplink data is to be transmitted.

In a thirty-fifth aspect, alone or in combination with one or more of the first through twenty-fourth aspects, the UE remains in the inactive state while transmitting the uplink data via the uplink RACH message or the configured uplink resource.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
determining, in an inactive state, that uplink data is to be transmitted;
determining whether a timing advance of the UE is valid;
if the timing advance is not valid, determining whether the uplink data satisfies a transport block size (TBS) threshold; and
based at least in part on whether the uplink data satisfies the TBS threshold, selectively:
transmitting the uplink data via an uplink random access channel (RACH) message or a configured uplink resource, or
establishing a radio resource control (RRC) connection for the uplink data.

2. The method of claim 1, wherein the UE remains in the inactive state while transmitting the uplink data via the uplink RACH message or the configured uplink resource.

3. The method of claim 1, wherein transmitting the uplink data via the uplink RACH message or the configured uplink resource is based at least in part on the uplink data being smaller than or equal to the TBS threshold.

4. The method of claim 1, wherein establishing the RRC connection is based at least in part on the uplink data being larger than the TBS threshold.

5. The method of claim 1, wherein transmitting the uplink data via the uplink RACH message or the configured uplink resource further comprises:
transmitting the uplink data via the uplink RACH message if the uplink data fails to satisfy an uplink grant threshold, wherein failing to satisfy the uplink grant threshold indicates that the uplink data can be accommodated in the uplink RACH message; and
transmitting the uplink data via the configured uplink resource if the uplink data satisfies the uplink grant threshold.

6. The method of claim 5, further comprising:
transmitting a request for the configured uplink resource prior to transmitting the uplink data via the configured uplink resource; and
receiving, based at least in part on the request, information configuring the configured uplink resource.

7. The method of claim 6, wherein the request is transmitted on the RACH message.

8. The method of claim 6, wherein the request indicates that the configured uplink resource is to include a single transport block of sufficient size to carry the uplink data.

9. The method of claim 6, wherein the request indicates that the configured uplink resource is to include multiple transport blocks that are distributed in time.

10. The method of claim 6, wherein the request indicates that the configured uplink resource includes recurring transport blocks until the configured uplink resource is deactivated.

11. The method of claim 6, further comprising:
transmitting the request based at least in part on determining that a periodic transmission is to be performed by the UE.

12. The method of claim 6, wherein the request comprises at least one of:
a medium access control control element,
an RRC parameter of an RRC resume request message, or
an RRC message.

13. The method of claim 12, wherein the request comprises a buffer status report message including an indication requesting the configured uplink resource.

14. The method of claim 12, wherein the request includes a buffer status report and a traffic pattern indication associated with the uplink data.

15. The method of claim 14, wherein the request further includes a resume identifier associated with the UE and an authentication token associated with the UE.

16. The method of claim 12, wherein the request comprises an RRC parameter indicating an amount of data associated with the uplink data and a traffic pattern indication associated with the uplink data.

17. The method of claim 6, wherein the information configuring the configured uplink resource is received via a downlink RACH message.

18. The method of claim 6, wherein the information configuring the configured uplink resource is received via an RRC release message or an RRC response associated with the request.

19. The method of claim 5, wherein the uplink grant threshold and the TBS threshold are configured by a same configuration message.

20. The method of claim 19, further comprising:
receiving an indication of whether to use an alternative TBS size for the TB S threshold.

21. The method of claim 20, wherein the TBS threshold is configured with a plurality of values, and wherein the indication indicates a subset of values, of the plurality of values, to be used as the TBS threshold.

22. The method of claim 1, further comprising:
receiving system information indicating the TBS threshold.

23. The method of claim 1, further comprising:
receiving, via dedicated RRC signaling, information indicating the TBS threshold.

24. The method of claim 1, wherein the TBS threshold is associated with a data radio bearer.

25. The method of claim 1, wherein the TBS threshold is specific to the UE.

26. The method of claim 1, wherein transmitting the uplink data via the RACH message or the configured uplink resource further comprises performing a one-shot transmission on the configured uplink resource.

27. The method of claim 1, wherein transmitting the uplink data via the RACH message or the configured uplink resource further comprises performing multiple transmissions on respective occasions of the configured uplink resource.

28. The method of claim 1, wherein, if the timing advance is determined to be valid, the method further comprises:
determining whether the configured uplink resource is configured and the uplink data can be accommodated in the configured uplink resource; and
if the configured uplink resource is configured and the uplink data can be accommodated in the configured uplink resource, transmitting the uplink data on the configured uplink resource.

29. The method of claim 28, wherein, if the uplink data cannot be accommodated in the configured uplink resource, the method further comprises:
transmitting a request for another configured uplink resource; and
transmitting the uplink data on the other configured uplink resource.

30. The method of claim 29, wherein the other configured uplink resource has a larger transport block size than the configured uplink resource.

31. The method of claim 29, wherein the request for the other configured uplink resource is transmitted in the configured uplink resource.

32. The method of claim 31, wherein, if the configured uplink resource is not configured, the method further comprises:
initiating a RACH procedure;
determining whether the uplink data satisfies the TBS threshold; and
based at least in part on whether the uplink data satisfies the TBS threshold, selectively:
transmitting the uplink data in connection with the RACH procedure,
transmitting a request for the configured uplink resource, or
establishing the RRC connection for the uplink data.

33. The method of claim 1, further comprising:
receiving configuration information indicating the configured uplink resource.

34. The method of claim 33, wherein the configuration information is based at least in part on subscription information associated with the UE

35. The method of claim 33, wherein the configuration information is based at least in part on network traffic information associated with the UE.

36. The method of claim 31, wherein the configured uplink resource is configured independently of whether the UE determines that uplink data is to be transmitted.

37. A user equipment, comprising:
one or more memories; and
one or more processors communicatively coupled to the one or more memories, configured to:
determine, in an inactive state, that uplink data is to be transmitted;
determine whether a timing advance of the UE is valid;
if the timing advance is not valid, determine whether the uplink data satisfies a transport block size (TBS) threshold; and
based at least in part on whether the uplink data satisfies the TBS threshold, selectively:
transmit the uplink data via an uplink random access channel (RACH) message or a configured uplink resource, or
establish a radio resource control (RRC) connection for the uplink data.

38. A non-transitory computer-readable medium storing instructions, the instructions comprising:
one or more instructions that, when executed by one or more processors, cause the one or more processors to:
determine, in an inactive state, that uplink data is to be transmitted;
determine whether a timing advance of the UE is valid;
if the timing advance is not valid, determine whether the uplink data satisfies a transport block size (TBS) threshold; and
based at least in part on whether the uplink data satisfies the TBS threshold, selectively:
transmit the uplink data via an uplink random access channel (RACH) message or a configured uplink resource, or
establish a radio resource control (RRC) connection for the uplink data.

39. An apparatus, comprising:
means for determining, in an inactive state, that uplink data is to be transmitted;
means for determining whether a timing advance of the apparatus is valid;
means for determining, if the timing advance is not valid, whether the uplink data satisfies a transport block size (TBS) threshold; and
means for, based at least in part on whether the uplink data satisfies the TB S threshold, selectively:
transmitting the uplink data via an uplink random access channel (RACH) message or a configured uplink resource, or
establishing a radio resource control (RRC) connection for the uplink data.
